(19) United States
(12) Patent Application Publication
(10) Pub. No.: US 2011/0118141 A1
(43) Pub. Date: May 19, 2011

(54) Disease Specific Diagnostic Aid

(75) Inventor: Michael J. Pugia, Granger, IN (US)

(73) Assignee: Siemens Healthcare Diagnostics Inc., Tarrytown, NY (US)

(21) Appl. No.: 13/054,123

(22) PCT Filed: Jun. 24, 2009
(86) PCT No.: PCT/US09/48463

§ 371 Date: Jan. 14, 2011

Related U.S. Application Data
(60) Provisional application No. 61/082,662, filed on Jul. 22, 2008.

(51) Int. Cl. C40B 30/04; C40B 40/00; C40B 60/12; C40B 40/04; C40B 40/10; C40B 40/12; C40B 40/02; C40B 40/18

(52) U.S. Cl. 506/9; 506/13; 506/39; 506/15; 506/18; 506/19; 506/14; 506/22

(57) ABSTRACT

A disease specific panel having at least one primary test for different analytes that are relevant for either early detection of a primary disease or management of patients already diagnosed with said primary disease. The panel also includes at least one secondary test which is relevant for detection of a co-morbid condition or complications of the primary disease. Generally, the primary and secondary tests are disposed on a support surface. The disease specific panel is different from the prior art creening tests in that there are no tests included in the panel whose results are not relevant or do not relate to either primary disease or a co-morbid condition or complications of the primary disease. The disease specific panel may also include systems and methods utilizing algorithms for creating and outputting diagnostic aids, as well as warnings about the presence of possible sample interferants, especially those commonly associated with the subject disease of the panel.

### FIELD OF THE INVENTION

This invention relates to improved medical diagnostic tests, and more specifically to improved diagnostic aids for particular patient groups and associated methods.

### BACKGROUND OF THE INVENTION

### Urinalysis Strips

Various analytical procedures and devices are commonly employed in assays to determine the presence and/or concentration of substances of clinical significance which may be present in biological fluids such as urine, whole blood, plasma, serum, sweat or saliva. Such substances are commonly referred to as analytes and can include specific binding partners, e.g. antibodies or antigens, drugs and hormones. One type of test device is commonly referred to as the dipstick, containing enzymes or reagents which are interactive with the analyte and will interact with it in a manner which results in an indicator changing color which can be correlated with the presence or, in a semi-quantitative methods, the concentration of the analyte in the fluid sample. The reagents are contained on or within absorbent pads positioned on the support surface of the strip. One such test strip is the Multistix® urine strip available from Siemens Healthcare Diagnostics Inc.

More recently there have been developed lateral flow test strips which operate on the principle of immunochromatography in which labeled antibodies, specific for the analyte are applied to a strip of absorbent material through which the test fluid and labeled antibodies can flow by capillarity. One such test cassette is the Clinitest® hCG Test cassette available from Siemens Healthcare Diagnostics Inc. The strip of absorbent material is generally placed within a cartridge or other support structure or surface. By immobilizing analyte (or an analog thereof) in a particular portion of the strip, i.e. capture zone, and measuring the amount of labeled antibody which is captured through specific binding, the concentration of analyte in the test sample can be semi-quantitatively determined. This lateral flow assay, in which the label is an enzyme and there is placed a substrate for the enzyme in the capture zone to provide a colored response, is more fully described in U.S. Pat. No. 4,446,232. In U.S. Pat. No. 4,703,017 there is described a similar assay in which the label is a particulate material which, upon aggregation in the capture zone due to specific binding between the immobilized analyte and particle labeled antibody, provides a visible detectable response.

While the detectable response obtained using such strips and similar tests can be observed visually to obtain a qualitative or semiquantitative measure of the analyte in the test sample, greater quantitation and faster, more reliable handling of multiple test strips can be realized by reading the developed test strips instrumentally, typically by the use of a reflectance spectrometer which determines the intensity of reflection from the test field surface. One such system is the CLINITEK STATUS® analyzer available from Siemens Healthcare Diagnostics Inc. It is useful for various medical diagnostic purposes to utilize a reflectance spectroscope to analyze samples of body fluid, for example, to determine the color of a person's urine. A conventional spectroscope may determine the color of a urine sample disposed on a white, non-reactive pad by illuminating the pad and taking a number of reflectance readings from the pad, each having a magnitude relating to a different wavelength of visible light. The color of the urine on the pad may then be determined based upon the relative magnitudes of red, green, blue and infrared reflectance signals.

Conventional spectroscopes may be used to perform a number of different urinalysis tests utilizing a reagent strip on which a number of different reagent pads are disposed. Each reagent pad may be provided with a different reagent which causes a color change in response to the presence of a certain type of constituent in urine, such as leukocytes (white blood cells) or red blood cells. Such a reagent strip may have ten or more different types of reagent pads. In a conventional spectroscope, the process of inspecting a reagent strip may be performed by dipping the reagent strip in a urine sample, blotting excess urine from the reagent strip, placing the reagent strip at a designated location in the spectrophotometer, and pressing a start button which causes the spectroscope to begin automatic processing and inspection of the reagent strip.

For example, U.S. Pat. No. 5,654,803, which is assigned to the assignee of the present disclosure and is incorporated herein by reference, discloses an apparatus and method for determination of non-hemolyzed levels of occult blood in urine. The apparatus is provided with a light bulb for successively illuminating a plurality of different portions of a reagent pad on which a urine sample is disposed, and a detector array for detecting light received from the reagent pad and generating a plurality of reflectance signals in response to light received from a corresponding one of the different portions of the reagent pad. The apparatus is also provided with means for determining whether the magnitude of one of the reflectance signals is substantially different from the magnitude of another of the reflectance signals. Where the body-fluid sample is urine, this capability allows the apparatus to detect the presence of non-hemolyzed levels of occult blood in the urine sample. The light bulb may successively illuminate a plurality of overlapping portions of the reagent pad, and may successively illuminate at least tree different portions of the reagent pad which are linearly offset from each other.

U.S. Pat. No. 5,945,341, which is also assigned to the assignee of the present disclosure and is incorporated herein by reference, discloses a system for the optical identification of coding on a diagnostic test strip and an automated method for reading a test strip for the analysis of the presence of one or more analytes in a liquid test sample. The method involves the spectrophotometric reading of a test strip which bears at least two marker fields on its surface which are capable of reflecting light at different spectral regions from each other. The means of the spectrophotometer is programmed to discern information concerning the strip, such as what analyte the strip is designed to detect, from the sequences of spectral classifications by spectral reflectance measurements of the strip's marker fields.

Currently, dipsticks or test strips are either broadly geared toward health screening for a variety of conditions or, on the other end of the spectrum, designed to test for a single analyte as an indicator of a specific condition. Previously, urinalysis reagent strips produced individual reagent results which the healthcare professional must examine, report, and interpret to impact patient health. For example, a panel of reagents measuring glucose, ketone, protein, urobilogen, bilirubin, leukocytes, blood, pH, specific gravity and nitrite in urine must each produce an individual result and each result must be interrelated with respect to a patient's condition. Traditionally, the results of the reagents themselves were the focus of the test, rather than the particular disease state of the patient. The problem is that when looking at a particular reagent, some result levels have more significance for one patient group over another. The identification of relevant reagents for a particular patient group and the interpretation of the reagent results in view of a particular disease state was left up to the operator or clinician. However, the interpretation may be impacted by individual user's training level. Additionally, this methodology requires time to complete the interpretation and to report the results to the patient.

There is an unmet need in the art for a strip that has a disease focus, rather than an individual reagent measurement focus, and combines only the most relevant reagent results for a particular patient group to output diagnostic aids along with reagent values. The test panel will only include tests that can be used to detect and/or quantify a number of different analytes that are indicators of the status of the disease state and comorbid conditions or complications of the primary disease state. These analytes that can be used to diagnose the condition and to follow the progression of the disease state and associated conditions on a single strip or other test format. Such a strip would be extremely useful for specialists treating patients suffering from a particular disease. Rather than having to purchase a number of urine strips, all the tests necessary for that particular disease across the entire disease progression would be available on the same strip test format. It would also be desirable if the analysis of the strips would include a diagnostic aid based on the results of the disease specific panel in addition to the individual test results.

Another problem with the current test strips is that sample interferences can cause falsely elevated or falsely lowered strip results. In urine, for example, these interferences include high specific gravity, which may cause falsely lowered glucose results as well as falsely lowered leukocyte results; elevated glucose, which may be another cause of falsely lowered leukocyte results; and high pH and visibly bloody urine, each of which may cause falsely elevated protein results. This is especially significant for patients in a particular group that may be more likely to have an interferant present in their body fluid. There is a need for algorithms which will alert the operator or clinician of occurrences of interferences; occurrences that may otherwise cause false-negative or false-positive results with strips lacking this technology.

As urine dipsticks contain multiple analyte tests in a single test strip, algorithms are needed to notify the user of certain effects found in urine due to interference of the analytes themselves. This is especially true for a panel whose results may be corrupted by interferences that may be more likely to be present in the specific patient population that the panel is directed toward. Urine can contain various interfering substances that could potentially cause false-positive or false-negative results on urine dipsticks. The kidneys produce urine with a specific gravity (a measure of urine concentration) typically in the range of 1.005 to 1.035. An elevated specific gravity in the upper part of this range can be due to dehydration, vomiting, diarrhea, glucosuria, or even decreased blood flow to the kidneys as a result of heart failure. Urine pH, which normally ranges from 4.6 to 8 is typically changed by diet. An acidic urine pH may be caused by a diet high in protein, whereas an alkaline urine pH may be due to a diet high in vegetables and fruits and sodium bicarbonate ingestion. Glucose is typically not found in normal urine. When glucose is present in the urine, it can indicate diabetes or renal glycosuria (abnormal glucose release from the kidneys into the urine). High glucose levels in urine can cause decreased leukocyte test results. Both elevated glucose and a high specific gravity can cause a falsely decreased result for leukocytes.

### SUMMARY OF THE INVENTION

One aspect of the invention involves the use of reagents in combinations or panels that are tailored to better manage specific disease states. Reagent results are used in an algorithm to allow fast and accurate interpretation of all results into one clinically meaningful outcome rather than only a string of reagent values. This system and method is useful in test strips for diagnostic aid for diabetes, inflammation and kidney disease. Quite unexpectedly, the selection and interpretation of reagent results was found to greatly impact diagnostic accuracy compared to the prior art methodology.

An object of the present invention is to provide new and improved test formats with a test panel including only the most relevant reagent results for a particular patient group into diagnostic aids.

A further object of the present invention is to provide new and improved methods and systems using reagent test results from a disease specific panel to produce a diagnostic aid.

Another object of the present invention is to provide new and improved kits having a disease specific test panel and instructions for use.

Still another object of the present invention is to provide methods and systems for providing flags or warnings notifying the operator of possible interferences with one or more of the reagent test results.

Briefly, in accordance with the present invention, these and other objects are attained by providing a disease specific panel having at least one primary test for different analytes that are relevant for either early detection of a primary disease or management of patients already diagnosed with said primary disease. The panel also includes at least one secondary test which is relevant for detection of a co-morbid condition or complications of the primary disease. Generally, the primary and secondary tests are disposed on a support surface. The disease specific panel is different from the prior art screening tests in that there are no tests included in the panel whose results are not relevant or do not relate to either primary disease or a co-morbid condition or complications of the primary disease.

The invention, in another aspect, includes a new and improved system and method for utilizing a disease specific algorithm to analyze a disease specific panel to generate a diagnostic aid.

Additional features and advantages of the invention will be made apparent from the following detailed description of illustrative embodiments that proceeds with reference to the accompanying drawings.

### BRIEF DESCRIPTION OF THE DRAWINGS

A more complete appreciation of the present invention and many of the attendant advantages thereof will be readily understood by reference to the following detailed description when taken in conjunction with the accompanying drawings, in which:

FIG. 1 shows three examples of disease specific diagnostic panels.

FIG. 2 contains the results summary showing that the sample note algorithm prevented invalid results for sample note strips.

### DESCRIPTION OF THE PREFERRED EMBODIMENTS

### Definitions

“Diagnostic aid” is an output value from a diagnostic test that is useful in the diagnosis or treatment of a patient.

“Disease Specific Panel” is a set of reagents used for assessment of a patient with a particular disease or condition.

“Patient group specific algorithm” is a set of one or more logic rules using reagent results from a disease specific panel to produce a diagnostic aid. The set of logic rules combine traditional algorithms with patient group settings.

In an effort to improve point-of-care diagnostic testing, a number of features have been developed and are disclosed herein that facilitate a more accurate and more meaningful diagnostic aid for clinicians to use. By focusing and customizing the diagnostic test on patients with a particular condition or disease, a number of improvements to the traditional systems and methods of diagnostic testing were devised.

In one embodiment of the present invention, a disease specific diagnostic panel combines only the most relevant reagent results for a particular patient group into diagnostic aids. Typically these panels take the form of reagent pads on a urine strip, so urine strips are used throughout as an example. However, it is understood that the invention is applicable to many formats including lateral flow cassettes or microfluidic chips or the like. It is also understood that the body fluids to be tested are not limited to urine, but rather include blood, as well as any other body fluid.

Instead of a single strip that has numerous reagents to screen for any number of diseases, only analytes whose values are relevant for a particular disease are found on the disease specific panel. Furthermore, the reagents relate to either diagnosing or managing a primary condition or they relate to a comorbid condition or effect of the primary condition. In this manner, a more efficient panel of tests are available for monitoring a patient group with a specific condition.

Another advantageous feature of the disease specific panel, is that it allows for the results of all reagents to be interoperated by an instrument (analyzer) into one or more diagnostic aids that are reported directly to the healthcare professional or other user, such as a patient. The diagnostic aids can take the form of a consideration displayed or otherwise outputted to the operator or clinician as a flag or note or the like conveying the message that the test results indicate a specific condition may be indicated. The diagnostic aid may be displayed on the analyzer output screen or reported along with the actual reagent values.

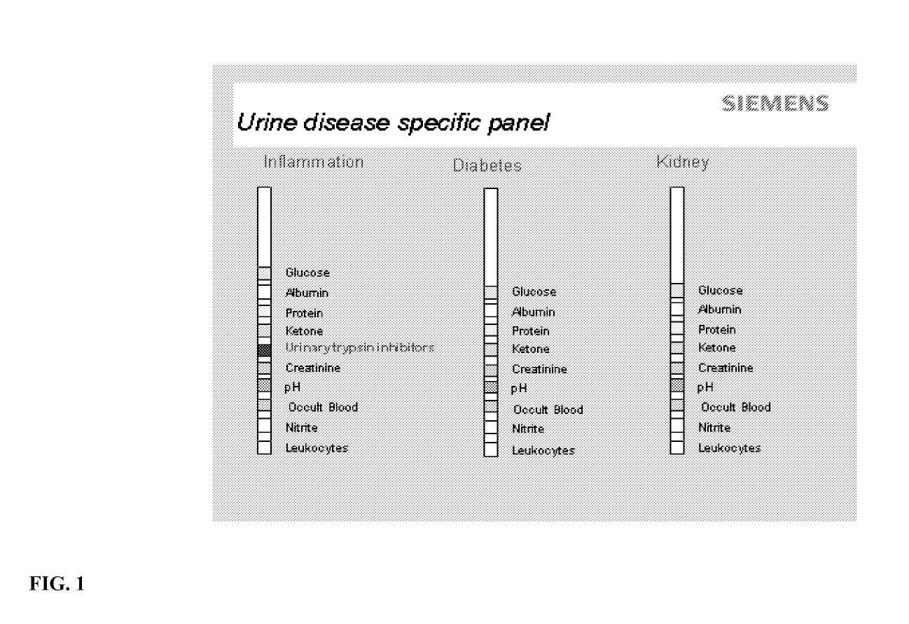

Three examples of disease specific panels are shown in FIG. 1 for patients with inflammation, diabetes, and kidney disease. Each example uses a panel of reagents for patients with inflammation, diabetes or kidney disease. For example, when a urinalysis is ordered for inflammation, only the panel for inflammation is analyzed and a diagnostic aid is reported back to the healthcare professional. The reagents in the panel only relate to inflammation or a comorbid condition.

An additional feature important to this invention is the use of color or IR identification and calibration bands to allow the analyzer to know which strip type is used on the instrument and to provide the analyzer with information, such as calibration, to produce the results needed to reports the diagnostic aid. It is also understood that there may be a default strip setting or an operator input to identify the test panel.

In one embodiment the steps of the invention are as follows:

1) The clinician uses the strip specific to the patient's disease type by dipping the strip into the patient's urine.

2) An analyzer examines the strip for the presence of identification markers to identify the disease specific panel.

3) The analyzer examines the strip for calibration information and uses this setting for the interpretation.

4) Reagents on the disease specific panel are read by the analyzer using a patient specific algorithm to produce a result.

5) The disease specific result output are read by the analyzer using patient group specific algorithm and converted to a diagnostic aid. If information for step 2 and 3 are not presented, the analyzer will use a default setting selected by the user.

In one embodiment, the panel of the present invention offers all urine tests that are important for the management of kidney disease throughout the continuum of care, from early detection through management of diagnosed and established disease. These tests are offered all at once in one testing step through a diagnostic testing format that offers all clinically relevant tests at the Point of Care; in this case, on a single strip.

For example, a strip for kidney disease containing reagent test pads for albumin, creatinine, and protein could be used as follows: Albumin-to-Creatinine ratio result in the microalbuminuria range detects early chronic kidney disease, while the Protein-to-Creatinine ratio result measures significantly higher concentration levels and so is useful for managing established kidney disease and for assessing the effectiveness of treatment. An occult blood test could also be included to detect kidney disorders, including kidney stones. If a patient has a kidney stone, a pH test included on the strip could help to determine which type of stone it is likely to be. Accordingly, the disease specific panel is helpful as a diagnostic aid for both early detection of a small stone that has not yet passed (blood in urine) through the continuum of care to understanding which type of stone has formed (urine pH) all on one diagnostic test menu.

Another aspect of the invention is the disease management focus by placing all relevant reagents on one diagnostic test device (strip) for use at the Point of Care. This idea involves offering additional diagnostic tests that can detect comorbid conditions or complications of the primary disease state. For example, a menu of tests for use in patients with diabetes would include urine glucose for detection of the disease and urine ketone to detect a metabolic disorder that occurs as a result of poor diabetes management. The menu would also include urine leukocyte and nitrite tests to detect Urinary Tract Infections (UTIs) and a urine albumin-to-creatinine ratio in the microalbuminuria range to detect early kidney disease. UTI and kidney disease are both conditions/complications that patients with diabetes are at high risk to develop.

Other examples include:

Infection—early detection of Urinary Tract Infection (UTI) with leukocyte and/or nitrite urinalysis tests and advanced tests that can assess the degree of sepsis. Ideally tests to determine whether an infection is bacterial or viral, and if bacterial, which antibiotic will be effective would also be included. These could all be put on one format to offer clinically relevant tests associated with infection on one diagnostic testing device.

Diabetes—blood glucose tests for early detection of diabetes are also helpful to detect poorly managed diabetes, and could be combined with the HbA1c test for assessing over a longer period the diabetes has been controlled on one testing format.

Unexpectedly, the use of the patient group specific panel and a patient specific algorithm had several non-obvious benefits over the prior art method of reading individual pad results (See Table 1 below). These benefits were shown in a scenario test of 3 lay users and 3 health care professionals.

Procedure for scenario test:

Three health care professionals were provided the result output for the urinalysis method. The urinalysis method was a panel of reagents for inflammation (shown in FIG. 1). The urinary trypsin result was 25 mg/dL, and the leukocyte results were trace. All other reagents gave indications that were neutral. The healthcare professionals were asked to identify the diagnosis and treatment. The healthcare professionals next explained the outcome to a lay person.

In this scenario test, the correct diagnosis was that the patient had an upper respiratory tract inflection. Using the individual pad method of the prior art, 2 of the 3 professionals identified the diagnosis incorrectly as urinary tract infection and implemented urine culture and antibiotics as the treatment. These actions were incorrect, as the patient had an upper respiratory infection. The method according to the present invention was more accurate. The time to explain the result to the lay user was also significantly shorter in the method of the invention. The faster explanation is due the diagnostic aid stating the reagents support an upper respiratory infection.

TABLE 1

| | Time for lay person | | Failure to | False positive |
|---|---|---|---|---|
| | to be explained | | correctly identify | identification |
| Method used | result (n = 3) | | treatment | of treatment |
| Individual | 8-12 | min | 2 of 3 | 2 of 3 |
| pad method | | | | |
| Patient group | 15-48 | sec | 0 of 3 | 0 of 3 |

specific algorithm

The increased accuracy is directly due to the accuracy of the patient group specific algorithm. Patient group specific algorithms are a set of logic rules using reagent result from a disease specific panel to produce a diagnostic aid.

Prior art methods are less accurate than the method of this invention. The traditional method for a semi-quantitative urinalysis panel is to compare individual reagent result to a reagent threshold limit and assign a concentration for all values above or below this reagent threshold limit. Two reagents can be ratio into one result and compared to a reagent threshold limit.

In Pugia, U.S. Pat. No. 6,306,660, a methodology was put forth to increase the accuracy of a semi-quantitative urinalysis panel by comparing individual reagent results to a threshold prior to making a ratio to another reagent. If the reagent was negative, then the ratio was negative. This worked, because the dynamic range of the individual reagent was wider than the dynamic range of the ratio. The errors of the first and second analytes are additive in a ratio. The specification provides guidance on how one would determine threshold limits by clinical studies relating disease to quantitative values and how to determine the dynamic ranges of reagents.

In the following tables, the new methodology is put forth to increase the accuracy of a semi-quantitative urinalysis panel. The new methodology is a patient group specific algorithm that compares three or more reagent result to make a single result in the form of a diagnostic aid. The result of each reagent is interpreted by an algorithm using a unique logic.

TABLE 2

| Example | Reagent A | Reagent B | Reagent C | Diagnostic aids |
|---|---|---|---|---|
| 1 | Albumin | Protein | Creatinine | Protein to |
| | | | | creatinine ratio |
| 2 | Albumin | Protein | Creatinine | Overly dilute |
| | | | | Sample |
| 3 | Leukocyte | Nitrite | Urinary trypsin | Urinary tract |
| | | | inhibitor | infection |
| 4 | Glucose | Ketone | Creatinine | Potential |
| | | | | diabetes |

The new methodology is demonstrated in Examples 1 to 4 which each produce a diagnostic aid from three reagents. Each example uses a patient group specific algorithm which features a new non-obvious step in the set of logic rules. This step examines one or more reagents for color, to check if it is above or below a “disease” threshold, rather than a “reagent” threshold. Whether the result is above or below a disease threshold changes how the results of the other two or more different reagents are interpreted to produce the diagnostic aid. The algorithms are generally present as software running on the CPU of the analyzer. It is understood that the developed algorithms could take the form of hardware or could be software run on a distributed system run in conjunction with the analyzer.

The disease threshold is a value assigned based on the accuracy of the diagnostic aid. Accuracy is measured by comparison of strip methodology to quantitative assays in which the results for the quantitative assay are assumed to be 100% correct. Correct identification of positives and negative results is both measured. The following table 3 shows the increased accuracy when using the new methodology compared to the standard methodology.

TABLE 3

| Example | Diagnostic aids | Standard methodology | New methodology |
|---|---|---|---|
| 1 | Protein to | 81% samples correct | 91% samples correct |
| | creatinine ratio | | |
| 2 | Overly dilute | 65% samples correct | 82% samples correct |
| | Sample | | |
| 3 | Urinary tract | 58% samples correct | 83% samples correct |
| | infection | | |
| 4 | Potential diabetes | 65% samples correct | 78% samples correct |

In Example 1, the new methodology uses the protein, albumin and creatinine reagents. According to the unique logic if the protein reagent is above a disease threshold for proteinuria, then the P:C ratio based on the protein and creatinine reagents is assigned a negative normal result. In this example, the new methodology was found best applied to a specific range of P:C ratio from 225 to 1000 mg/g.

In contrast, the standard method as described in Pugia '660 uses only the protein and creatinine reagents in reporting to the clinician, which in this case is the protein to creatinine ratio (P:C). As described in the '660 patent, the standard method must first examine the protein reagent color and if the result is below the dynamic range threshold, a negative P:C ratio is reported, otherwise the ratio of the protein to creatinine reagents are compared to a disease threshold and a P:C ratio result reported. As can be seen in the accuracy of new methodology to predict a P:C ratio at >225 mg/g is greater than the standard methodology. The new method is contrary to the teaching of Pugia '660 because protein results below the disease threshold produces a positive P:C ratio, not the negative result. Also, the disease threshold must be well within the dynamic range of the reagent.

In Example 2, the new methodology uses the protein, albumin and creatinine reagents. If the albumin and creatinine reagents are above a disease threshold for diuresis, then the P:C ratio based on the protein and creatinine reagents is assigned a diagnostic aid indicating a dilute sample (diuresis). The standard method would be to measure diuresis based solely on a measure of urine concentration, in this case creatinine less than 25 mg/dL is commonly accepted method. As can be seen in the accuracy of new methodology to predict a diuresis at >25 mg/dL is greater than the standard methodology.

The new method is contrary to the teaching of Pugia '660 because creatinine results below the disease threshold produce a positive diuresis result not the negative result. Also, the disease threshold must be well within the dynamic range of the creatinine reagent.

In Example 3, the new methodology uses the leukocyte, nitrite and urinary trypsin inhibitor reagents. If the urinary trypsin inhibitor reagents are below a disease threshold for severe infection, then a trace leukocyte would be assigned a diagnostic aid of other infection and not urinary tract infection. The standard method would be to measure leukocyte or nitrite reagents with a positive result of either accepted as an indication of urinary tract infection. As can be seen in the accuracy of new methodology to predict a urinary tract infection (based on bacteriuria of >10̂5 cell/mL) is greater than the standard methodology.

The new method is contrary to the teaching of Pugia '660 because urinary trypsin inhibitor result is below the disease threshold produces a positive result for other infection not the negative result. Also, the disease threshold must be well within the dynamic range of the urinary trypsin inhibitor reagent.

In Example 4, the new methodology uses the ketone, glucose and creatinine reagents. If the creatinine reagents are below a disease threshold for concentrated urine (>200 mg/dL), then a trace glucose of 25 mg/dL would be assigned a diagnostic aid as indication of diabetes. The standard method would be either a positive glucose result (>100 mg/dL) with or without positive ketone result accepted as an indication of diabetes. As can be seen in the accuracy of new methodology to predict diabetes is greater than the standard methodology.

The new method is contrary to the teaching of Pugia '660 because creatinine result below the disease threshold produces a positive glucose result, not the negative diagnostic aid result. Also, the disease threshold must be well within the dynamic range of the creatinine reagent.

Another aspect of the invention, are notifications or sample notes that indicate the presence of interferences in the sample. Algorithms were devised which will alert the user of these interference occurrences on the analyzer, occurrences that may otherwise cause false-negative or false-positive results with strips lacking this technology. The new algorithms significantly reduce false-positive and false-negative results with urine strips that may occur from urine sample interferences. Urine strips with and without these algorithms were compared. Effects of the various sample interferences on the urine strips were reduced by as much as 100%.

In the following example, five sample interference note conditions and algorithms were evaluated using 10 laboratory-prepared solutions designed to simulate effects from clinical urines. To ensure proper comparison and study control, negative and positive levels for affected reagents were also included. These solutions are listed in Table 4 and the sample note test conditions are found in Table 5.

TABLE 4
Test solutions.

| Solution | Analyte | Concentration | | Addition | |
|---|---|---|---|---|---|
| 1 | Leukocyte, | LEU, 0 cells/μL; | | N/A | |
| | Glucose, | GLU, 0 mg/mL; | | | |
| | Protein | PRO, 30 mg/dL | | | |
| 2 | Leukocyte, | LEU, 11.8 cells/μL; | | N/A | |
| | Protein | PRO, 0.0 mg/dL | | | |
| 3 | Leukocyte | 11.8 | cells/μL | Glucose, 500 | mg/dL |
| 4 | Leukocyte | 11.8 | cells/μL | SG, 1.030 | |
| 5 | Glucose | 100 | mg/dL | N/A | |
| 6 | Glucose | 100 | mg/dL | SG, 1.030 | |
| 7 | Protein | 0 | mg/dL | Blood, 0.405 | mg/dL |
| 8 | Protein | 30 | mg/dL | Blood, 0.405 | mg/dL |

| | | | | |
|---|---|---|---|---|
| 9 | Protein | 0 | mg/dL | pH, 9.0 |
| 10 | Protein | 30 | mg/dL | pH, 9.0 |

SG = specific gravity

TABLE 5
Sample note test conditions.

| Affected | Sample | Affecting | Test | | Solution |
|---|---|---|---|---|---|
| Reagent | Note | Condition | Solutions | | Reference |
| Leukocyte | Normal | N/A | Negative | | 1 |
| | | | 11.8 | cells/μL | 2 |
| Leukocyte | High | Glucose ≧ 250 | 11.8 | cells/μL | 3 |
| | Glucose/ | mg/dL | | | |
| | Lowered | | | | |
| | Leukocyte | | | | |
| Leukocyte | High SG/ | SG ≧ 1.025 | 11.8 | cells/μL | 4 |
| | Lowered | | | | |
| | Leukocyte | | | | |
| Glucose | Normal | N/A | Negative | | 1 |
| | | | 100 | mg/dL | 5 |
| Glucose | High SG/ | SG ≧ 1.025 | 100 | mg/dL | 6 |
| | Lowered | | | | |
| | Glucose | | | | |
| Protein | Normal | N/A | Negative | | 2 |
| | | | 30 | mg/dL | 1 |
| Protein | Visible | Blood ≧ 0.405 | Negative | | 7 |
| | Blood/ | mg/dL | 30 | mg/dL | 8 |
| | Elevated | | | | |
| | Protein | | | | |
| Protein | High pH/ | pH ≧ 8.5 | Negative | | 9 |
| | Elevated | | 30 | mg/dL | 10 |
| | Protein | | | | |

SG = specific gravity

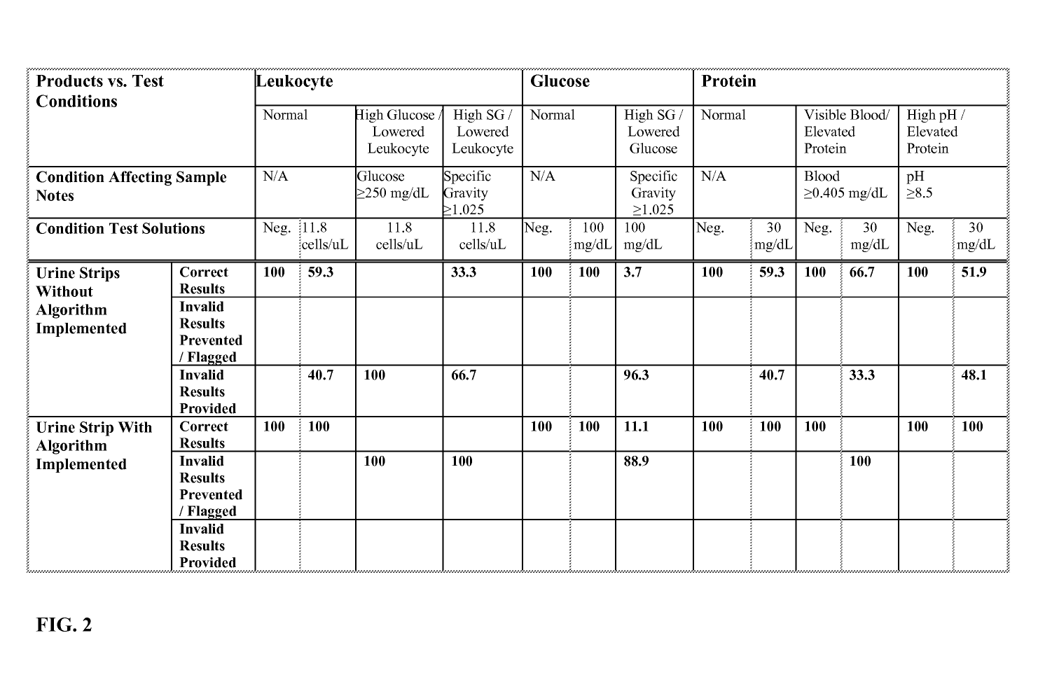

The results were compared for urine strips with the sample note algorithm and for urine strips without the algorithm implemented. FIG. 2 contains the results summary showing that the sample note algorithm prevented invalid results for sample note strips. At the same time, the algorithm flagged 100 percent of the invalid results for sample note strips. The urine strips run without the sample note algorithm showed a high percentage of false-positive or false-negative results.

Clearly, there are many advantages provided by the sample notes of the present invention. As can be seen from the table, sample note algorithms reduced false results by as much as 100 percent. A sample flagged as having a high specific gravity could prompt the clinician to obtain an additional sample that is less concentrated. False-negative results could lead to a patient's not receiving treatment or confirmatory testing. False-positive results can lead to additional testing and/or treatment that may not be necessary. The algorithms are generally present as software running on the CPU of the analyzer. It is understood that the developed algorithms could take the form of hardware or could be software run on a distributed system run in conjunction with the analyzer. It is understood that the interferant values chosen are used as an example. The threshold can be set higher or lower depending upon the sensitivity of the diagnostic test being carried out. As a general rule the interferant thresholds are set at the point where the interferant begins to materially interfere with the result of another one of the reagents. Material interference is the point at which the variation is clinically relevant. It is also important to consider the frequency of the warnings. The threshold must be balanced against warning frequency so that a warning is not issued frequently for even small interferences.

While the present invention has been described in connection with the exemplary embodiments, it is not limited thereto and it is to be understood that other similar embodiments may be used or modifications and additions may be made to the described embodiments for performing the same function of the present invention without deviating therefrom. Therefore, the present invention should not be limited to any single embodiment, but rather should be construed in breadth and scope in accordance with the appended claims. Also, the appended claims should be construed to include other variants and embodiments of the invention, which may be made by those skilled in the art without departing from the true spirit and scope of the present invention.

I claim:

1. A disease specific panel, comprising:
at least one primary test for different analytes; wherein test results from said at least one primary test is relevant for either early detection of a primary disease or management of patients already diagnosed with said primary disease;
at least one secondary test, wherein test results from said at least one secondary test are relevant for detection of a co-morbid condition or complications of said primary disease;
said primary and secondary tests disposed on a support surface; and
wherein there are no other tests disposed on said support surface whose test results are not relevant to either said primary disease or a co-morbid condition or complications of said primary disease.

2. The panel of claim 1, wherein said primary and secondary tests are reagent pads.

3. The panel of claim 1, wherein said primary and secondary tests are reagent stripes on a lateral flow assay.

4. The panel of claim 1, wherein said support surface is a microfluidic chip.

5. The panel of claim 1, wherein said primary disease is chronic kidney disease and wherein primary tests are protein, creatinine, and microalbumin.

6. The panel of claim 5, further comprising a secondary test of occult blood to detect kidney stones as a complication of chronic kidney disease.

7. The panel of claim 6, further comprising a secondary test of pH.

8. The panel of claim 1, wherein said primary disease is diabetes and wherein said primary test is urine glucose and said at least one secondary test is at least one of urine ketone, creatinine, protein, microalbumin, urine leukocyte and nitrite.

9. An automated diagnostic testing method, comprising the steps of:
reading, with an analyzer, a disease specific diagnostic panel having one or more test reagents corresponding to a particular condition to obtain a result value for each reagent;
comparing one or more of said result values against a condition threshold indicative of a specific condition;
outputting a diagnostic aid if said one or more result values is beyond the condition threshold; and
outputting said result values.

10. The method of claim 9 further comprising the step of: if said one or more result value is not beyond the condition threshold, said diagnostic aid is not outputted.

11. The method of claim 9 further comprising the step of: if said one or more result value is not beyond the condition threshold, a diagnostic aid suggestive of the absence of said specific condition is outputted.

12. The method of claim 9, wherein said disease specific panel includes reagents for protein and creatinine and said disease threshold is for proteinuria, and if the result value of said protein reagent on said panel is above said proteinuria threshold, then a then a diagnostic aid is outputted indicating a negative normal result.

13. A system for conducting a diagnostic test, comprising:
an analyzer for reading a disease specific diagnostic panel having one or more test reagents corresponding to a particular condition to obtain a result value for each reagent; and
software for
comparing one or more of said result values against a condition threshold indicative of a specific condition;
if said one or more result values is beyond the condition threshold, a diagnostic aid suggestive of said specific condition is outputted;
and
outputting said result values.

14. The system of claim 13, wherein said software further comprises the logic that if said one or more result value is not beyond the condition threshold said diagnostic aid is not outputted.

15. The system of claim 13, wherein said software further comprises the logic that if said one or more result value is not beyond the condition threshold a diagnostic aid suggestive of the absence of said specific condition is outputted.

16. A method for a diagnostic test comprising the steps of:
reading a diagnostic panel having one or more test reagents to obtain a result value for each reagent;
comparing one or more of said result values against an interferant threshold;
if said one or more result values are outside said interferant threshold, outputting a warning; and
outputting said result values.

17. The method of claim 16, wherein said interferant threshold is Glucose ≧250 mg/dL.

18. The method of claim 17, wherein said warning indicates high glucose may result in a lowered leukocyte result value.

19. A system for a diagnostic test comprising the steps of:
an analyzer for reading a diagnostic panel having one or more test reagents to obtain a result value for each reagent; and
software for
comparing one or more of said result values against an interferant threshold, and if said one or more result values are outside said interferant threshold, a warning is outputted; and
outputting said result values.
